(19) United States
(12) Patent Application Publication
(10) Pub. No.: US 2013/0298950 A1
(43) Pub. Date: Nov. 14, 2013

(54) CLEANING APPARATUS

(71) Applicant: David Hann, Shorncliffe Queensland (AU)

(72) Inventor: David Hann, Shorncliffe Queensland (AU)

(73) Assignee: Raymond Alan Farrier, Bayswater (AU)

(21) Appl. No.: 13/980,079

(22) PCT Filed: Jan. 16, 2012
(86) PCT No.: PCT/AU2012/000026

§ 371 Date: Jul. 17, 2013

(30) Foreign Application Priority Data
Jan. 17, 2011 (AU) 2011900127

(51) Int. Cl. B08B 3/02

(52) U.S. Cl. CPC B08B 3/024
USPC 134/56 R; 134/172; 134/180

(57) ABSTRACT

A cleaning apparatus (10) for an elongate line (30), the cleaning apparatus (10) comprising an apparatus carriage (11) and a plurality of high pressure water jet nozzles (23) mounted thereto, said apparatus carriage (11) is positionable proximal to the elongate line (30) and adapted to move along the length of the elongate line (30) enabling the high pressure water jet nozzles (23) to clean the elongate line (30).

### TECHNICAL FIELD

The present invention relates to a cleaning apparatus. The present invention has particular but not exclusive application to cleaning marine mooring and anchor chains.

### BACKGROUND ART

Large oil production, storage and offloading tankers, often referred to as FPSOs or FSOs, are generally semi-permanently moored to the seabed using large link diameter steel mooring chains in order to hold stationary at an offshore production location. Tanker mooring facilities are typically arranged in a multi-chain spider leg configuration. Each chain is secured at the seabed by an anchor and at the surface by a mooring buoy. The FPSO or FSO vessel is tethered to the mooring buoy. The vessel is usually connected to the mooring buoy at or close to its bow, so that the vessel can hold the bow into the wind and waves whilst maintaining a small positional footprint above seabed production facilities. In this manner, FPSOs and FSOs can be moored at an exposed offshore location in water depths of up to 600 metres. At locations with water depths exceeding 150 metres, mooring legs typically comprise a combination of chain and high strength wire rope in order to reduce the overall weight of the mooring legs.

Due to the high value of both vessel and cargo, FPSOs and FSOs are insured to cover all possible operational and environmental risks. In order to qualify for insurance, owners must ensure that their vessels and associated mooring systems have been designed in accordance with the highest possible accepted industry standards. Most vessels are therefore designed in accordance with the rules and guidelines of an accredited international classification society such as Lloyd's of London or the American Bureau of Shipping. In addition to design rules, the classification society also impose strict operational maintenance and inspection protocols for the vessel and associated systems, including the mooring system.

In order to maintain the mooring system, including the anchor, chain, wire rope and buoy, the components must be inspected to determine the extent of operational wear and tear. A critical component of the mooring system is the mooring chain as the chain links can corrode and wear due to the constant rubbing of the links against each other. Inspection of the chain is typically either carried out by divers in shallow water (less than 20 metres), or by remotely operated vehicles (ROVs) at depths in excess of 20 metres.

Before the chain can be inspected, it must be cleaned of all rust and marine growth so that critical parts of each link may be viewed by video camera. Cleaning is generally carried out by divers or ROVs. Generally a high pressure water jet cleaning lance is used to blast away the marine growth covering the chain links. This method has the drawback of being inefficient since the tip of the water jet can only clean a relatively small portion of the chain surface at any one time. The task can be dangerous as the chain links can move under the typically high operational mooring tension. This can result in a diver trapping fingers or parts of his equipment between the moving links.

The remotely operated vehicle also has the additional disadvantage of only being able to clean in accordance with directions by the surface operator who is viewing the operation through a CCTV camera whilst operating a joy stick controlled manipulator arm with the water jet attached. This can result in inadequate cleaning. The result is dependent on the skill of the operator, but is also affected by movement of the water and turbidity caused by rust and marine growth dislodged during the cleaning process.

It is an object of the present invention to provide cleaning apparatus which overcomes at least in part one or more of the above mentioned disadvantages, or provides a useful alternative thereto.

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

Reference to cited material or information contained in the text should not be understood as a concession that the material or information was part of the common general knowledge or was known in Australia or any other country.

Throughout this specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the term “elongate line” is to be understood to include within its scope a length of any of chain, rope, cord, cable or wire.

### SUMMARY OF INVENTION

In accordance with the present invention there is provided a cleaning apparatus for an elongate line, the cleaning apparatus comprising an apparatus carriage and a plurality of high pressure water jet nozzles mounted thereto, said apparatus carriage being positionable proximal to the elongate line and adapted to move along the length of the elongate line enabling the high pressure water jet nozzles to clean the elongate line.

Preferably, the elongate line comprises a length of chain.

Preferably, the apparatus carriage further comprises at least one cleaning arm to which a plurality of high pressure water jet nozzles is mounted.

Preferably, the apparatus carriage is adapted to move along the length of the elongate line enabling the high pressure water jet nozzles to clean along the elongate line.

Preferably, the apparatus carriage has at least one clamping arm.

More preferably, there are at least two opposing clamping arms mounted to and forming part of the apparatus carriage. The at least two clamping arms are preferably arcuate in shape to surround and capture the elongate line. The at least two clamping arms are preferably pivotally mounted to enable the arms to come together and move apart relative to each other. Movement of the arms is preferably actuated by pneumatic or hydraulic pistons.

The one or more clamping arms preferably has low friction guides to allow smooth movement of the captured elongate line through the cleaning apparatus. Preferably, each of the clamping arms has one or more buoyancy sections.

The at least one cleaning arm is preferably pivotally mounted on one end of the apparatus carriage. Preferably, there are two opposing cleaning arms pivotally mounted on one end of the apparatus carriage. Each of the opposing cleaning arms preferably has a plurality of nozzles to direct a stream of water towards the opposing arm.

In other embodiments there are one or more sets of opposing cleaning arms positioned along the length or at the other end of the apparatus carriage. In one embodiment, there is one pair of cleaning arms located at the front end of the elongate line cleaning apparatus. Preferably, the pair of cleaning arms is adapted to open up to allow an elongate line to be positioned between the arms. The cleaning arms can then close around the elongate line during the cleaning operation.

Preferably, the cleaning arms are shaped to enable them to substantially surround the circumference of the elongate line when in the deployed (closed) position so that the cleaning apparatus can substantially clean all sides of the elongate line in a single pass. When the cleaning arms are not in use, preferably they can be moved to a stowed position.

Preferably, the cleaning arms are pivotally attached to the apparatus carriage to allow the cleaning arms to be folded away when not in use.

Preferably, the cleaning apparatus is adapted for operation by remote control.

Preferably, the cleaning apparatus can move along the elongate line in a geometrically precise, velocity controlled manner by at least one winch assembly.

Preferably, the winch assembly is operated by an electric motor. The winch assembly is preferably connected to the elongate line by a wire and hook assembly. More preferably there is a winch assembly located at either end of the elongate line cleaning apparatus. The wire portion of the wire and hook assembly is preferably about 30 metres in length.

Preferably, the cleaning apparatus can clean the elongate line in a single pass. However, the cleaning apparatus can preferably be pulled back and forth along a piece of elongate line by means of two wire winches to effect a more thorough clean.

The various features of the cleaning apparatus discussed in the specification can be combined in a variety of arrangements to form cleaning apparatus of different embodiments.

The present invention in a further aspect provides a cleaning apparatus for a chain, the apparatus comprising:

an apparatus carriage positionable proximal to the chain, said apparatus carriage has at least two opposing clamping arms to surround and capture the chain, each of said clamping arms has at least one buoyancy section;

at least two cleaning arms mounted to the apparatus carriage, each of the cleaning arms has a plurality of high pressure water jet nozzles to direct a stream of water towards the opposing cleaning arm;

at least one winch assembly one winch assembly to move the cleaning apparatus along the chain, said winch assembly including a length of wire with a hook attached at the free end;

wherein the apparatus carriage is adapted to capture and move along the chain while high pressure water jet nozzles direct a stream of water onto the chain.

Preferably, the cleaning apparatus has a front winch assembly and a rear winch assembly by which it may move back and forth along the chain.

Preferably, the high pressure water jets are mounted on a pair of cleaning arms attached to a hinged frame assembly at the front end of the carriage. Preferably when the high pressure water jets are in position for cleaning they are in close proximity to the chain surface. Preferably, multiple sensors mounted on the cleaning arms detect the orientation and proximity of individual links as they pass thorough the cleaning apparatus. This facilitates independent activation or de-activation of the individual cleaning jets to maximize cleaning efficiency and maintain maximum water pressure in the water jets. The sensors are preferably operated mechanically, acoustically or by means of magnetic switches.

Preferably, at least one device mounted on the apparatus carriage monitors the chemical and physical properties of the chain during operation of the cleaning apparatus.

Preferably, the services such as water, hydraulics and electrical power required to operate the cleaning apparatus are generated by a surface support vessel and supplied to the cleaning apparatus by means of a combined cable and hose tether (an umbilical). This umbilical may also be used to lower the cleaning apparatus to the chain, and to recover the apparatus to the surface when cleaning is finished. The umbilical is preferably fitted with buoyancy aids.

Preferably, the cleaning apparatus is suitable for underwater cleaning of marine mooring chains. The cleaning apparatus is preferably suitable for ‘open’ or ‘stud-link’ chains.

### BRIEF DESCRIPTION OF THE DRAWINGS

In order that the present invention can be more readily understood reference will now be made to the accompanying drawings which illustrate a preferred embodiment of the invention and wherein:

FIG. 1 is a diagrammatic view of a preferred embodiment of the cleaning apparatus;

FIG. 2 is an exploded view of the cleaning apparatus of FIG. 1;

FIG. 3 is a diagrammatic front end view of the cleaning apparatus of FIG. 1 wherein the clamping arms are in an open position and the cleaning arms are stowed. A mooring chain is shown in cross section; and

FIG. 4 is a diagrammatic front end view of the cleaning apparatus of FIG. 1 wherein the clamping arms are in a closed (chain capturing) position and the cleaning arms surround the chain. A mooring chain is shown in cross section.

### DESCRIPTION OF EMBODIMENTS

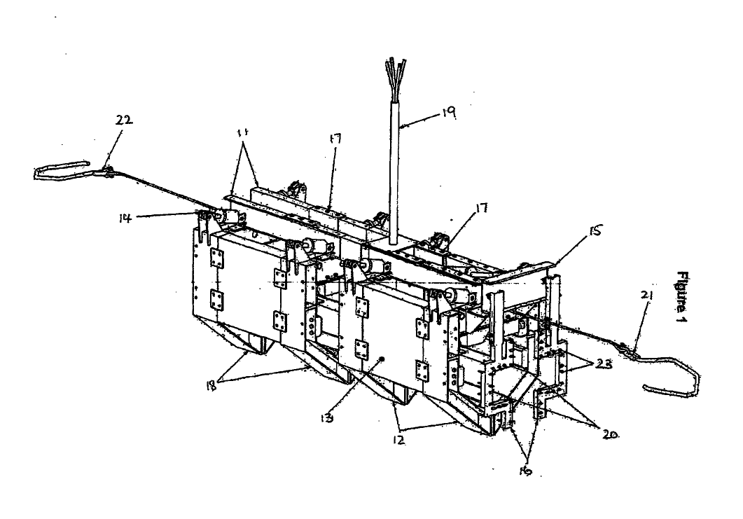

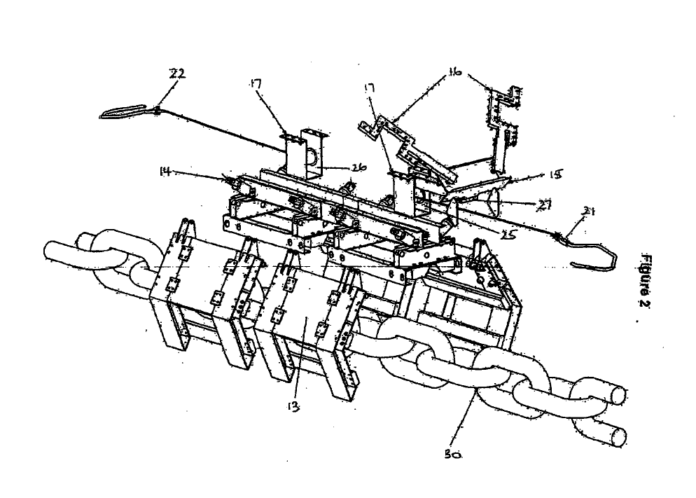

With reference to FIGS. 1 and 2 there is shown a cleaning apparatus 10. The cleaning apparatus 10 has an apparatus carriage 11. The apparatus carriage 11 has a front clamping arm 12 and rear clamping arm 18 pivotally mounted to allow the cleaning apparatus 10 to be clamped to a elongate line, for example a mooring chain 30 during the cleaning process. Each clamping arm 12 and 18 is arcuate shaped so that opposing clamping arms can surround and capture a mooring chain 30. Each clamping arm 12 and 18 is actuated by a pivotally mounted hydraulic piston 14. Each of the clamping arms 12 and 18 has a buoyancy panel 13 to assist with the floatation of the cleaning apparatus 10.

The cleaning apparatus 10 has a front winch 25 and a rear winch 26. The front winch 25 and the rear winch 26 are each mounted on the apparatus carriage 11 by a winch support 17. In use, the front and rear winches 25 and 26 are attached to the mooring chain 30 by a front hook and wire 21 and a rear hook and wire 22 to enable the cleaning apparatus 10 to be moved along the length of the mooring chain 30. The winches 25, 26 are operated by electric motors. Low friction guides 20 direct the cleaning apparatus 10 along the mooring chain 30.

A pair of cleaning arms 16 are pivotally mounted to a cleaning arm mounting assembly 15, which is in turn mounted at the front end of the apparatus carriage 11. Each arm 16 has an array of high pressure water jet nozzles 23. During cleaning, the mounting assembly 15 positions the cleaning arms 16 about the mooring chain 30.

The cleaning arms 16 are shaped so that, when they are in the deployed position, they substantially surround the chain so that that all sides of the chain can be cleaned in a single pass. When the cleaning apparatus 10 has finished cleaning the chain, the cleaning arms 16 are opened to release them from engagement with the chain. The mounting assembly 15 is rotated outwards towards the apparatus carriage 11 about a hinge 27 so that the cleaning arms 16 can be rotated away from the front end of the cleaning apparatus 10 and stowed on top of the apparatus carriage 11.

The services necessary for the operation of the cleaning apparatus 10, including electricity, water and hydraulics, are supplied through a services tether (umbilical) 19. The umbilical can be fitted with buoyancy aids (not shown). The services can be generated onboard a surface support vessel, and supplied to the cleaning apparatus 10 at any depth. At greater depths the services may be generated and supplied by a submersible remotely controlled vehicle (ROV, not shown) accompanying the cleaning apparatus 10. The services tether 19 may also be used to lower the cleaning apparatus 10 to the working depth, and to recover it to the surface when cleaning is finished.

After the cleaning apparatus 10 is at the required depth, the ROV can move the cleaning apparatus 10 to a position where it is suspended just above the mooring chain 30. The ROV can then be used to pull the front hook and wire 21 out by around 30 metres and attach it to a link in the mooring chain 30. The ROV then clamps on to the rear of the cleaning apparatus 10 and positions the cleaning apparatus 10 onto the mooring chain 30. The front and rear clamping arms 12 and 18 are then closed by the surface operator so that they surround and capture the mooring chain 30, and the cleaning arms 16 are deployed in the cleaning position by the surface operator. The ROV is disengaged from the cleaning apparatus 10.

Multiple chain sensors (not shown) are mounted on the cleaning arms 16. The chain sensors are activated by the surface operator, and the water flow to the water jet nozzles 23 is initiated. The chain sensors detect the orientation and proximity of the links of the mooring chain 30 as the links pass through the cleaning arms 16 in order to facilitate independent activation or deactivation of individual cleaning jets to maximize cleaning efficiency and maintain maximum water pressure to the jet nozzles 23.

Multiple chain monitoring devices (not shown) are mounted within the cleaning apparatus 10. The chain monitoring instruments are activated by the surface operator, and are employed to monitor the chemical and physical properties of the chain. The chain monitoring instruments are able to measure the corrosion potential, mechanical wear and elongation of the chain in order to determine where repairs may be required.

The front winch 25 is used to drag the cleaning apparatus 10 along the mooring chain 30. After the cleaning apparatus 10 has travelled approximately 25 metres up the chain, the ROV can disconnect the front hook and wire 21 from the mooring chain 30 and pull the wire out another 30 metres and secure it again to the mooring chain 30 to allow cleaning to continue along the length of the mooring chain 30.

After cleaning is complete, the stream of water from the nozzles 23 is stopped, the cleaning arms 16 are opened to release them from the mooring chain 30 and the cleaning arms 16 are returned to the stowed position. The front and rear clamping arms 12 and 18 are opened to release the cleaning apparatus 10 from the mooring chain 30. The cleaning apparatus 10 returns to the surface using the services tether 19.

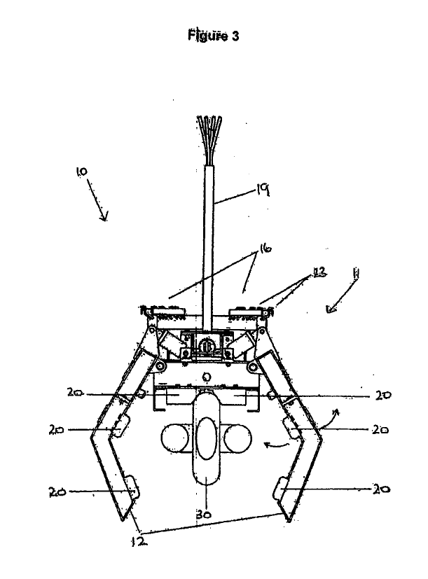

With reference to FIG. 3, there is shown the cleaning apparatus 10 surrounding a mooring chain 30 with the front clamping arm 12 in an open position. The cleaning arms 16 are in a stowed position, folded back towards the apparatus carriage 11.

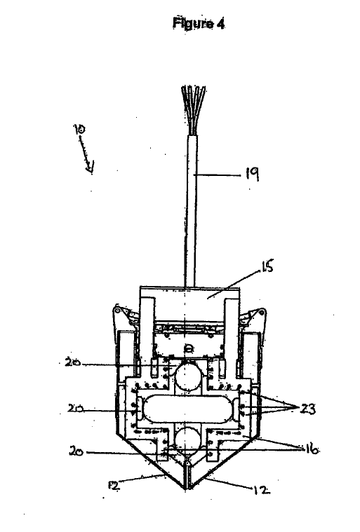

FIG. 4 shows the cleaning apparatus 10 in an operational mode with the clamping arm 12 in a closed position surrounding the mooring chain 30. The low friction guides 20 are positioned around the mooring chain 30 to direct the cleaning apparatus 10 along the length of the mooring chain 30. The cleaning arms 16 are deployed about the mooring chain 30 in the operational cleaning position with the high pressure water jet nozzles 23 directed towards the mooring chain 30.

An advantage of the preferred embodiment of the cleaning apparatus is that it provides a method of cleaning mooring chains by a remote cleaning apparatus thereby providing an efficient cleaning method that avoids the problems associated with manual cleaning. The cleaning apparatus can traverse along a mooring chain in a geometrically precise, velocity controlled manner. The cleaning apparatus provides a stable, non-vibrating support platform for cleaning apparatus allowing the mooring chain to be cleaned to a high standard.

The configuration of the cleaning arms allows the chain to be surrounded by water jets allowing the mooring chain to be cleaned with one pass of the cleaning apparatus.

The cleaning apparatus provides an automated alternative that does not rely on a surface operator having to use closed circuit television to control a manipulator arm carrying a water jet. This method is reliant on the skill of the operator, as well as dependence on good visibility in the water and the effects of tides and currents.

The cleaning apparatus provides a safer alternative to conventional cleaning methods for mooring chains. There is no requirement for divers to clean the chain manually, thus removing the risk of divers trapping fingers or equipment in moving chain links.

The use of multiple sensors to detect the orientation and proximity of individual links and activate and de-activate individual cleaning jets maximizes the efficiency of the cleaning system.

1. A cleaning apparatus for an elongate line, the cleaning apparatus comprising an apparatus, at least one winch assembly of high and a plurality of high pressure water jet nozzles mounted thereto, said apparatus carriage being positionable proximal to the elongate line and adapted to move along the length of the elongate line, by which the winch assembly enabling the high pressure water jet nozzles to clean the elongate line.

2. A cleaning apparatus according to claim 2, wherein the elongate line comprises a length of chain.

3. A cleaning apparatus according to claim 1, wherein the apparatus carriage further comprises at least one cleaning arm to which a plurality of high pressure water jet nozzles is mounted.

4. A cleaning apparatus according to claim 1, wherein, the apparatus carriage is adapted to move along the length of the elongate line enabling the high pressure water jet nozzles to clean along the elongate line.

5. A cleaning apparatus according to claim 1, wherein the apparatus carriage has at least one clamping arm.

6. A cleaning apparatus according to claim 5, wherein there are at least two opposing clamping arms mounted to and forming part of the apparatus carriage.

7. A cleaning apparatus according to claim 5, wherein, the at least two clamping arms are arcuate in shape to surround and capture the elongate line.

8. A cleaning apparatus according to claim 5, wherein the at least two clamping arms are pivotally mounted to enable the arms to come together and move apart relative to each other.

9. A cleaning apparatus according to claim 5, wherein movement of the or each arm is actuated by pneumatic or hydraulic pistons.

10. A cleaning apparatus according to claim 5, wherein the or each clamping arm has low friction guides to allow smooth movement of the captured elongate line through the cleaning apparatus.

11. A cleaning apparatus according to claim 5, wherein the or each clamping arm has one or more buoyancy sections.

12. A cleaning apparatus according to claim 3, wherein the or each cleaning arm is pivotally mounted on one end of the apparatus carriage.

13. A cleaning apparatus according to claim 12, wherein there are provided two opposing cleaning arms pivotally mounted on one end of the apparatus carriage.

14. A cleaning apparatus according to claim 13, wherein each of the opposing cleaning arms has a plurality of nozzles to direct a stream of water towards the opposing arm.

15. A cleaning apparatus according to claim 12, wherein there are one or more sets of opposing cleaning arms positioned along the length, or at the other end, of the apparatus carriage.

16. A cleaning apparatus according to claim 15, wherein there is one pair of cleaning arms located at a front end of the cleaning apparatus.

17. A cleaning apparatus according to claim 15, wherein the pair of cleaning arms is adapted to open up to allow a elongate line to be positioned between the arms, allowing the cleaning arms to close around the elongate line during the cleaning operation.

18. A cleaning apparatus according to claim 15, wherein the cleaning arms are shaped to enable them to substantially surround the circumference of the elongate line when in the deployed (closed) position so that the elongate line cleaning apparatus can substantially clean all sides of the elongate line in a single pass.

19. A cleaning apparatus according to claim 15, wherein the cleaning arms are pivotally attached to the apparatus carriage to allow the cleaning arms to be folded away when not in use.

20. A cleaning apparatus according to claim 1, wherein the cleaning apparatus is adapted for operation by remote control.

21. A cleaning apparatus according to claim 1, wherein the cleaning apparatus can move along the elongate line in a geometrically precise, velocity controlled manner by at least one winch assembly.

22. A cleaning apparatus according to claim 21, wherein the winch assembly is operated by an electric motor.

23. A cleaning apparatus according to claim 21, wherein the winch assembly is connected to the elongate line by a wire and hook assembly.

24. A cleaning apparatus according to claim 23, wherein the wire portion of the wire and hook assembly is approximately 30 metres in length.

25. A cleaning apparatus according to claim 21, wherein there is a winch assembly located at either end of the cleaning apparatus.

26. A cleaning apparatus according to claim 21, wherein the cleaning apparatus can move in two directions along the length of the elongate wire by means of two wire winches to effect a more thorough clean.

27. A cleaning apparatus for a chain, the apparatus comprising:
an apparatus carriage positionable proximal to the chain, said apparatus carriage has at least two opposing clamping arms to surround and capture the chain, each of said clamping arms has at least one buoyancy section;
at least two cleaning arms mounted to the apparatus carriage, each of the cleaning arms has a plurality of high pressure water jet nozzles to direct a stream of water towards the opposing cleaning arm; and
at least one winch assembly one winch assembly to move the cleaning apparatus along the chain, said winch assembly including a length of wire with a hook attached at the free end,
wherein the apparatus carriage is adapted to capture and move along the chain while high pressure water jet nozzles direct a stream of water onto the chain.

28. A cleaning apparatus according to claim 27, wherein the cleaning apparatus has a front winch assembly and a rear winch assembly by which it may move back and forth along the chain.

29. A cleaning apparatus according to claim 27, wherein the high pressure water jets are mounted on a pair of cleaning arms attached to a hinged frame assembly at the front end of the carriage.

30. A cleaning apparatus according to claim 29, wherein the high pressure water jets are in position for cleaning they are in close proximity to the chain surface.

31. A cleaning apparatus according to claim 27, wherein multiple sensors mounted on the cleaning arms detect the orientation and proximity of individual chain links as they pass thorough the cleaning apparatus to facilitate the independent activation or de-activation of the individual cleaning jets to maximize cleaning efficiency and maintain maximum water pressure in the water jets.

32. A cleaning apparatus according to claim 31, wherein the sensors are operated mechanically, acoustically or by means of magnetic switches.

33. A cleaning apparatus according to claim 27, wherein at least one device mounted on the apparatus carriage monitors the chemical and physical properties of the chain during operation of the cleaning apparatus.

34. A cleaning apparatus according to claim 27, wherein services such as water, hydraulics and electrical power required to operate the cleaning apparatus are generated by a surface support vessel and supplied to the cleaning apparatus by means of a combined cable and hose tether (an umbilical).

35. A cleaning apparatus according to claim 34, wherein the umbilical may also be used to lower the cleaning apparatus to the chain and to recover the apparatus to the surface when cleaning is finished.

36. A cleaning apparatus according to claim 35, wherein the umbilical is fitted with buoyancy aids.

37. (canceled)
